(19) United States
(12) Patent Application Publication
(10) Pub. No.: US 2026/0229897 A1
(43) Pub. Date: Aug. 6, 2026

(54) FLEXIBLE AC-DC-AC ELECTRICAL DISTRIBUTION INTERCONNECTION SYSTEM

(71) Applicant: UNIVERSITY OF NEWCASTLE UPON TYNE, Newcastle upon Tyne, Tyne and Wear (GB)

(72) Inventor: Matthew DEAKIN, Newcastle upon Tyne, Tyne and Wear (GB)

(21) Appl. No.: 19/152,286

(22) PCT Filed: Feb. 1, 2024
(86) PCT No.: PCT/GB2024/050285

§ 371 Date: Jul. 30, 2025

(30) Foreign Application Priority Data
Feb. 3, 2023 (GB) 2301566.2

(51) Int. Cl. H02J 3/38; H02J 3/007

(52) U.S. Cl. CPC H02J 3/38; H02J 3/007

(57) ABSTRACT

There is provided an apparatus for power conversion at a node of an electrical distribution network, comprising a first quantity of electrical feeders; a second quantity of AC/DC converters; and a multiplexer arranged to electrically connect the first quantity of electrical feeders to the second quantity of AC/DC converters, wherein the second quantity is greater than the first quantity.

### BACKGROUND

The present disclosure relates generally to alternating current (AC) power distribution networks. Power converters are an important part of power systems, providing an interface between power distribution networks and low-carbon technologies, such as solar photovoltaics, wind generators, heat pumps, and electric vehicles, each of which tend to be decentralised systems by their nature. These low-carbon technologies are often connected to power distribution networks, and therefore an increase in overall network capacity is required due to the shift of heating and transport from fossil fuels to electrical power. Due to the flexibility and controllability of technologies based on power converters, these power converter technologies can be installed within the distribution network to increase distribution network capacity, reduce system losses, and address issues with power quality. However, the cost of semiconductor switches in power converters remains high compared to classical power technologies, limiting their uptake.

Semiconductor-assisted hybrid technologies exploit the controllability of small, partially rated converters to increase the performance of AC systems whilst reducing the costs of expensive semiconductor components. Systems making use of such an approach include Unified Power Flow Controllers (UPFCs), Hybrid Power Transformers, Hybrid On-Load Tap Changers, or Doubly-Fed Induction Generators (DFIGs).

### BRIEF SUMMARY

There is provided an apparatus for power conversion at a node of an electrical distribution network, comprising a first quantity of electrical feeders; a second quantity of AC/DC converters; and a multiplexer arranged to electrically connect the first quantity of electrical feeders to the second quantity of AC/DC converters, wherein the second quantity is greater than the first quantity.

### BRIEF DESCRIPTION OF THE DRAWINGS

Further details, aspects and embodiments of the invention will be described, by way of example only, with reference to the drawings. In the drawings, like reference numbers are used to identify like or functionally similar elements. Elements in the figures are illustrated for simplicity and clarity and have not necessarily been drawn to scale.

FIG. 1 shows a conventional soft open point (SOP) at a node with two feeders and two AC/DC converters;

FIG. 2 shows a conventional SOP at a node with three feeders and three AC/DC converters;

FIG. 3 shows a two-terminal multiplexed SOP, in accordance with examples of the disclosure;

FIG. 4 shows a three-terminal multiplexed SOP, in accordance with examples of the disclosure;

FIG. 5 shows an alternative three-terminal multiplexed SOP, in accordance with examples of the disclosure;

FIG. 6A shows a two-terminal multiplexed SOP, with bisected converter sizing, in accordance with examples of the disclosure;

FIG. 6B shows an example capability chart for the two-terminal multiplexed SOP of FIG. 6A;

FIG. 7A shows a two-terminal multiplexed SOP, with golden ratio converter sizing, in accordance with examples of the disclosure;

FIG. 78 shows an example capability chart for the two-terminal multiplexed SOP of FIG. 7A;

FIG. 8 shows an example of a SOP connected to a DC technology at the DC bus, in accordance with examples of the disclosure;

FIG. 9A shows an example of a two-terminal multiplexed SOP, with a mix of reconfigurable and fixed converters, in accordance with examples of the disclosure;

FIG. 9B shows an example capability chart for the two-terminal multiplexed SOP of FIG. 9A.

### DETAILED DESCRIPTION

In the following description, for purposes of explanation, numerous specific details of certain examples are set forth. Reference in the specification to “an example” or similar language means that a particular feature, structure, or characteristic described in connection with the example is included in at least that example, but not necessarily in other examples.

In some examples herein, values are given using the per-unit system (pu). The per-unit system uses base values, with selected parameters compared to selected base values and assigned per-unit (pu) values.

One power converter technology is the Soft Open Point (SOP). This approach involves replacement of Normally Open Points (NOPs) in a distribution system with back-to-back AC/DC converters that enable flexible power transfer between adjacent feeder lines without the need for meshed protection.

Where two feeder lines meet at a NOP, back-to-back voltage source converters can be installed to form a SOP, allowing for power to be transferred whilst maintaining radiality of the power distribution network. Where three or more feeder lines meet at a NOP, a Multi-Terminal SOP (MT-SOP) can be installed in place of the NOP.

A MT-SOP with n terminals comprises n feeders, and n AC/DC converters. Each of the AC/DC converters is hard-wired to a given feeder, and so the topology of the converter is fixed with respect to the distribution network. Typically, these converters have uniform maximum power conversion capacity

SOPs and MT-SOPs can provide network capacity, and opportunities for reduced operating costs. However, AC/DC power converters are typically expensive on a power-rated basis, and therefore there is a benefit to maximising the utilisation of these converters.

A multiplexed SOP (MOP) comprises m feeders connected through a multiplexer to the AC side of n AC/DC converters. The feeders may require both real and reactive power transfers. The MOP is designed to maximise the utilisation of power electronics in the transfer of real and reactive power. The multiplexer may comprise a plurality of multi-terminal electromechanical AC switches, arranged to selectively couple a feeder of the m feeders to one or more of the n AC/DC converters, with the multiplexer allowing each of the n converter to be electrically connected to up to one of the m feeders. These electromechanical AC switches may be composed of a plurality of power relays or contactors

The feeder, converter and switch configurations displayed in the figures each show an arrangement for a single phase system. It will be appreciated that the methods and configurations described herein also apply to multiple-phase systems, such as three-phase systems, using the same approach. A single phase only is shown in the figures for ease of representation.

The sizing (i.e. maximum power conversion capacity) of the AC/DC converters can have a substantial impact on the realisable power transfers that are feasible.

In a uniform sizing approach for determining maximum power conversion capacity of each of the n AC/DC converters, each of the n converters are equally sized with 1/n pu capacity.

In a bisection sizing approach for determining maximum power conversion capacity of each of the n AC/DC converters, the first converter is sized at 0.5 pu, with the next n−2 converters thereafter sized with half the size of the preceding converter. The final converter is the same size as the penultimate converter. For example, for three converters, the capacities would be 0.5 pu, 0.25 pu and 0.25 pu. For four converters, the capacities would be 0.5 pu, 0.25 pu, 0.125 pu and 0.125 pu.

In a golden ratio sizing approach for determining maximum power conversion capacity of each of the n AC/DC converters, the first converter is sized at 0.5 pu. The rest of the converters are then sized incrementally by splitting the smallest converter into two converters according to the golden ratio. For example, for three converters, the capacities would be 0.5 pu, 0.31 pu and 0.19 pu. For four converters, the capacities would be 0.5 pu 0.31 pu, 0.12 pu and 0.07 pu.

Both the golden ratio sizing approach and the bisection sizing approach have the advantage that maximum possible real power can always be transferred between feeders, due to the 0.5 pu capacity of the first converter, but the splitting of the subsequent converters yields a capability chart with good general characteristics. A capability chart, as referred to herein, describes the mathematical set of all combinations of feasible real and reactive powers that can be injected or drawn from a SOP or MOP:

The bisection sizing approach has the advantage that it can be created by composing the converter out of a number of modules. For example, if the smallest converter has a size x, then the other converters can be created as sizes x, 2x, 4x, etc. up to the largest converter.

In contrast, the golden ratio sizing approach has the benefit that it has a larger capability chart than the bisection sizing approach for reasonably small number of converters. However, multiples of smaller converter modules cannot be combined to make the converters for the golden ratio sizing approach.

Both the bisection and golden ratio sizing approaches consist of one large converter, with progressively smaller converters, whilst the uniform sizing approach has n converters that are uniform in size but get progressively smaller for larger n.

An alternative sizing approach is the use of ‘mission profile’ optimized sizing. In this profile optimization sizing approach, the goal is to find the smallest total capacity of AC/DC power converters that is required to meet a given level of service (for example, a set of power transfers required) within a network for a given number of reconfigurable converters.

For this profile optimization sizing approach, a ‘mission profile’ may be determined for the location on a network at which the set of converters will be installed. To determine this mission profile, a network operator may use a Typical Meteorological Year (TMY) and/or historic meteorological data to model variable renewable technologies (such as wind and solar), load duration curves (e.g. residential or commercial demand) and/or time series or representative metered data for conventional loads. The mission profile can then be determined using an optimization or rule based approach. The mission profile may consist of, for example, hourly power transfers that the set of power converters would be required to meet at each hour of the year in order to appropriately manage network congestion, including the management of voltage constraints and/or thermal constraints.

Some surplus points can be stripped out of this mission profile. For example, if the mission profile is determined on an hour-by-hour basis for a whole calendar year, then this would consist of 8760 points. Some of these point would not be required if they fall within other points. For example, if a vector of power transfers, p1, is a fraction of another vector, p2 (e.g. p1=0.5*p2), then if the design can transfer p1 then it can also transfer p2. This step, although not required, can make determination of the optimized sizing more computationally efficient.

This mission profile can then be passed into an optimization problem in order to determine the minimum total capacity of converters required to meet this mission profile for a given number of power converters, n. This optimization can be carried out using mixed-integer linear optimization programs, metaheuristics, or quantum computing optimization approaches. In general, these algorithms find the minimum total power conversion capacity for some number of converters, n, such that there exists a number of switch states, Bₖ, for all p points in the mission profile. Mathematically, an optimization problem describing this may be:

$$min \sum γ$$

$${S}_{k} \leq {B}_{k} γ ∀ k ∈ \{ 1 , … , p \}$$

$$\sum {B}_{k} [ : , J ] = 1 ∀ j ∈ \{ 1 , … , n \} , ∀ k ∈ \{ 1 , … , \}$$

where m is the number of feeders (greater than or equal to 2), n is the number of converters (greater than or equal to 2), p is the number of powers in the mission profile over which optimization must be performed, Bₖ is an m×n binary matrix representing the state of all multiplexer switches for a point k of the mission profile, y is an n-vector with the j^{th} element as the j^{th} converter capacity, and Sₖ is an m-vector of the kth apparent power transfers in the mission profile.

The first equation of this optimization problem states that the objective of the optimization is to minimise the total capacity of AC/DC converters. The second equation of this optimization problem states that the capacity connected to each feeder (Bₖy) must be (elementwise) greater than the power transfers for all points, for each point. The third equation of the optimization problem states that the column sum of each multiplexer state matrix Bₖ must be equal to 1. This ensures that each converter can be connected to only one feeder at a time.

This optimization problem may additionally include a base problem or limitation, such as a modular limitation. For a modular limitation, instead of any capacity of converter being possible, an integer number of a smallest module y₀ are connected in parallel.

Through use of a mission profile and a profile optimization sizing approach, modularity can be achieved in order to provide simpler deployment of converters. For example, a single unit containing 30 power converters of a standard fixed size may be deployed. As part of the installation of this unit, hardwired parallel connections between these converters may be made in order to create the required combinations of converter sizes for connecting to the multiplexer. Such a modular configuration provides scope for reconfigurability in future, where demands or the mission profile may change. Additionally, this modularity provides scope for improved maintenance of the converter devices.

An example of this optimization, considering two feeders with both real and reactive power requirements, may be as follows. In an example with m=2 feeders, a network operator may wish to transfer a mission profile with the following six powers:

$$( 500 kW + 0 kVAr , - 500 kW ) ;$$

$$( 400 kW + 440 kVAr , - 400 W ) ;$$

$$( 300 kW + 630 kVAr , - 300 kW ) ;$$

$$( 200 kW + 770 kVAr , - 200 kW ) ;$$

$$( 100 kW + 890 kVAr , - 100 kW ) ;$$

$$( 1000 kVAr , 0 kW ) .$$

In this example, if only n=2 converters are used, then the smallest capacity that can meet this mission profile is 1400 kVA, with two converters of capacities 900 kVA and 500 kVA.

Alternatively, if n=3 converters are used, then the smallest capacity that can meet this mission profile is 1100 kVA, with three converters of capacities 500 kVA, 400 kVA and 200 kVA.

If however n=4 converters are used, then the smallest capacity that can meet this mission profile is the smallest possible capacity of 1000 kVA, with four converters of capacities 400 kVA, 300 kVA, 200 kVA and 100 kVA. There is no further benefit in terms of reduced AC/DC capacity in increasing the number of converters beyond n=4 converters, for this example,

An alternative example of this optimisation, considering three feeders and only real power requirements, may be as follows. In an example with m=3 feeders a network operator may determine from the mission profile that the real power transfer for the three feeder converter should be able to achieve real power transfers of:

$$( 500 kW , - 500 kW , 0 kW ) ;$$

$$( 500 kW , - 333 kW , - 167 kW ) ;$$

$$( 500 kW , - 250 kW , - 250 kW ) ;$$

$$( 500 kW , - 309 kW , - 191 kW ) ;$$

$$( 500 kW , - 450 kW , - 50 kW ) .$$

Additionally, every permutation of these power transfers (with respect to feeders) should also be achievable (for example (−50 kW, 500 kW, −450 kW)).

In this example, if n=3 converters are used, then the smallest capacity that can meet this mission profile is 1200 kVA, with three converters of capacities 500 kVA, 450 kVA and 250 kVA.

Alternatively, if n=4 converters are used, then the smallest capacity that can meet this mission profile is 1025 kVA, with four converters of capacities 500 kVA, 274 kVA, 191 kVA and 59 kVA.

If n=5 converters are used, then the smallest capacity that can meet this mission profile is 1003 kVA, with five converters of capacities 500 kVA, 197.3 kVA, 138.3 kVA, 114,4 kVA and 52.7 kVA.

If however n=6 converters are used, then the smallest capacity that can meet this mission profile is 1000 kVA, the smallest possible capacity for this example, with six converters of capacities 500 kVA, 250 kVA, 59 kVA, 24 kVA, 117 kVA and 50 kVA. There is no further benefit in terms of reduced AC/DC capacity in increasing the number of converters beyond n=6 converters, for this example.

In some applications, it may be advantageous to install the smallest possible AC/DC converter capacity of 1 pu (for example, using all 6 AC/DC converters, in the above example). In other applications, it may be preferable to install a power converter with a larger AC/DC converter capacity, but with a smaller number of converters (such as n=4, in the above example), in order to limit the number of switches included in the multiplexer.

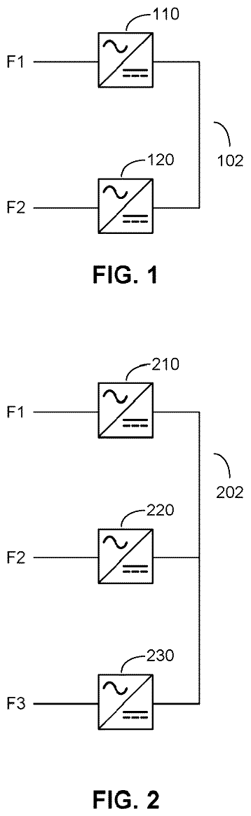

FIG. 1 shows a conventional two-terminal SOP, at a node with two feeders and two AC/DC converters. A first AC/DC converter 110 is hard-wired to a first feeder F1. A second AC/DC converter 120 is hard-wired to a second feeder F2. The AC/DC converters 110, 120 are connected to a common DC bus 102. First AC/DC converter 110 and second AC/DC converter 120 have uniform maximum power conversion capacity.

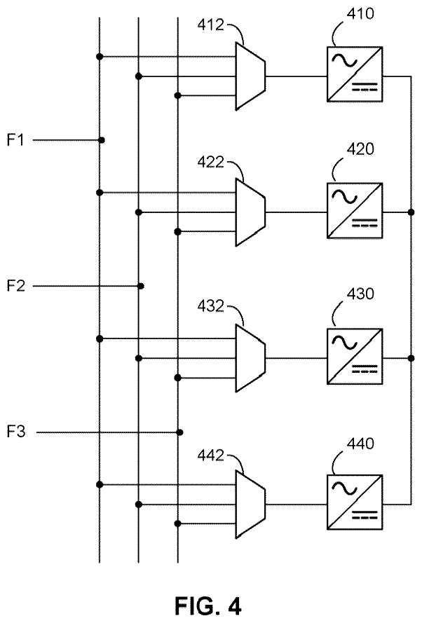

If 100 kVA is to be transferred to the common DC bus 102 at the node, then a conventional approach is to use a SOP with a 100 kVA maximum power conversion capacity AC/DC converter 110, 120, is required between each node F1, F2, and the common DC bus 102. In total, this requires 200 kVA of power conversion capacity at the SOP. For this two terminal case, a benefit is obtained in terms of the amount of reactive power that can be transferred. These benefits are described further in relation to FIG. 3.

The real and reactive power constraints imposed by the fixed converter configuration of FIG. 1 are static, and cannot be changed as distribution network conditions change.

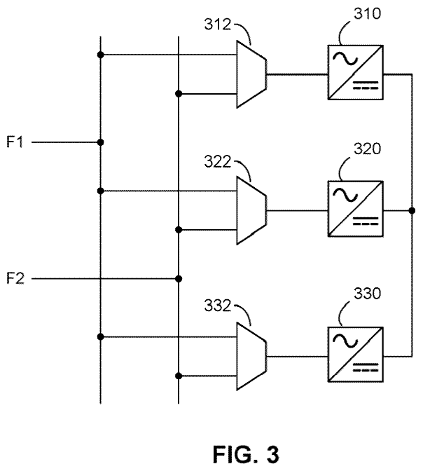

FIG. 2 shows a conventional three-terminal SOP, at a node with three feeders and three AC/DC converters. A first AC/DC converter 210 is hard-wired to a first feeder F1. A second AC/DC converter 220 is hard-wired to a second feeder F2. The AC/DC converters 210, 220, 230 are connected to a common DC bus 202. A third AC/DC converter 230 is hard-wired to a third feeder F3. First AC/DC converter 210, second AC/DC converter 220, and third AC/DC converter 230 have uniform maximum power conversion capacity.

If 100 kVA is to be transferred between any two feeders at a node with three feeders, then a conventional approach is to use a SOP with a 100 kVA maximum power conversion capacity AC/DC converter 210, 220, 230, between each node F1, F2, F3, and the common DC bus 202. In total, this requires 300 kVA of AC/DC power conversion capacity at the SOP.

The real and reactive power constraints imposed by the fixed converter configuration of FIG. 2 are static, and cannot be changed as distribution network conditions change.

FIG. 3 shows a two-terminal MOP, in accordance with examples of the disclosure. According to FIG. 3, a first feeder F1 is electrically connected to a first input of each of power switches 312, 322, 332. A second feeder F2 is electrically connected to a second input of each of power switches 312, 322, 332. First power switch 312 is electrically connected to an AC-side of a first AC/DC converter 310, with first power switch 312 operable to selectively couple first AC/DC converter 310 to one of feeder F1 or feeder F2. Second power switch 322 is electrically connected to an AC-side of a second AC/DC converter 320, with second power switch 322 operable to selectively couple second AC/DC converter 320 to one of feeder F1 or feeder F2. Third power switch 332 is electrically connected to an AC-side of a third AC/DC converter 330, with third power switch 332 operable to selectively couple third AC/DC converter 330 to one of feeder F1 or feeder F2. A DC-side of each of AC/DC converters 310, 320, 330, is connected to a common DC node.

The real and reactive power constraints imposed by the multiplexed converter configuration of FIG. 3 can be changed as distribution network conditions change. To demonstrate the benefits of this two-terminal MOP, consider an example of 0.3 pu real power transferred between feeders F1 and F2. For a conventional two-converter case, such as that shown in FIG. 1, with converters 110 and 120 each sized at 0.5 pu, the reactive power compensation that can be provided (for example, to reduce losses or provide voltage regulation) is limited to 0.4 pu. If instead one 0.5 pu converter is split into an 0.3 pu sized converter and an 0.2 pu sized converter (such as converters 320, 330 of FIG. 3), then the maximum reactive power that can be provided to either feeder is increased to 0.632 pu, which is a 58% increase compared to the conventional SOP system of FIG. 1.

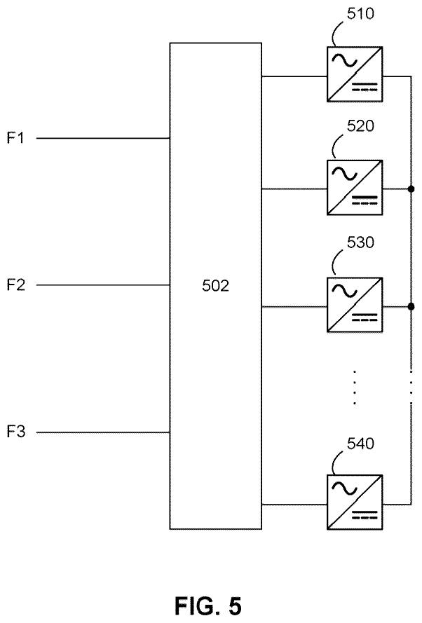

FIG. 4 shows a three-terminal MOP, in accordance with examples of the disclosure. According to FIG. 4, a first feeder F1 is electrically connected to a first input of each of power switches 412, 422, 432, 442. A second feeder F2 is electrically connected to a second input of each of power switches 412, 422, 432, 442. A third feeder F3 is electrically connected to a third input of each of power switches 412, 422, 432, 442. First power switch 412 is electrically connected to an AC-side of a first AC/DC converter 410, with first power switch 412 operable to selectively couple first AC/DC converter 410 to one of feeder F1, feeder F2, or feeder F3. Second power switch 422 is electrically connected to an AC-side of a second AC/DC converter 420, with second power switch 422 operable to selectively couple second AC/DC converter 420 to one of feeder F1, feeder F2, or feeder F3. Third power switch 432 is electrically connected to an AC-side of a third AC/DC converter 430, with third power switch 432 operable to selectively couple third AC/DC converter 430 to one of feeder F1, feeder F2, or feeder F3. Fourth power switch 442 is electrically connected to an AC-side of a fourth AC/DC converter 440, with fourth power switch 442 operable to selectively couple fourth AC/DC converter 440 to one of feeder F1, feeder F2, or feeder F3. A DC-side of each of AC/DC converters 410, 420, 430, 440, is connected to a common DC node,

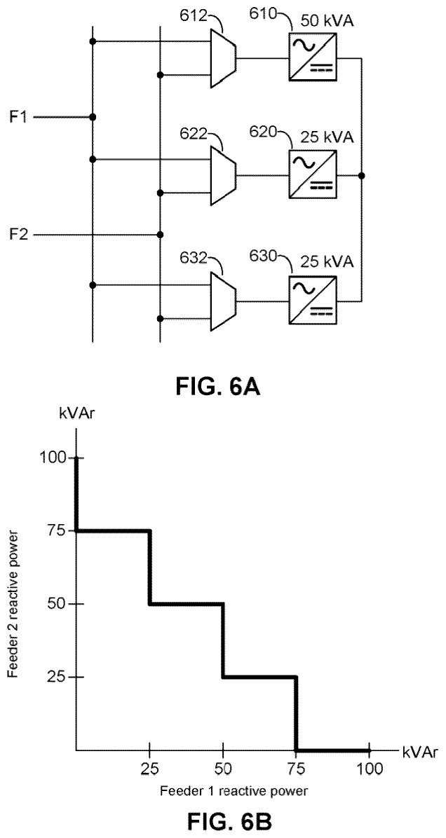

FIG. 5 shows an alternative three-terminal MOP, in accordance with examples of the disclosure. According to FIG. 5, feeders F1, F2 and F3 are each electrically connected to an input of multiplexer 502. AC-sides of AC/DC converters 510, 520, 530, 540 are each electrically connected to an output of multiplexer 502. Multiplexer 502 is operable to selectively couple each output to one input. Each output may be coupled to only a single input, however each input may be coupled to multiple outputs. Accordingly, multiplexer 502 may be operable to couple each of feeders F1, F2, F3, to one or more of AC/DC converters 510, 520, 530, 540. A DC-side of each of AC/DC converters 510, 520, 530, 540, is coupled to a common DC node.

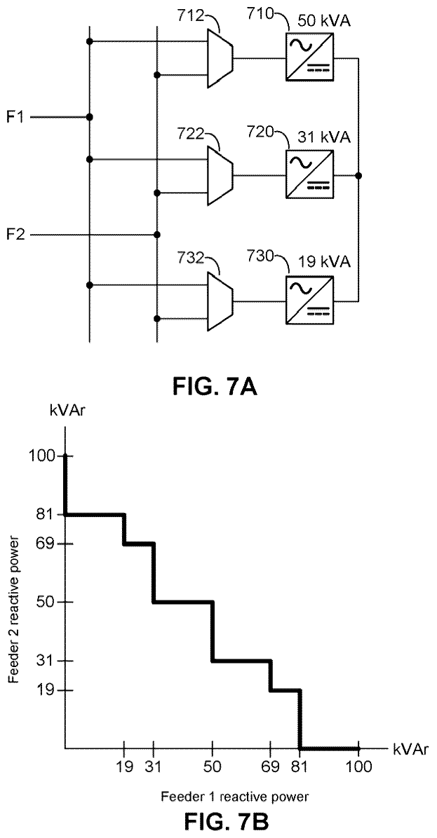

FIG. 6A shows a two-terminal multiplexed SOP, with bisected converter sizing, in accordance with examples of the disclosure. A first feeder F1 is electrically connected to a first input of each of power switches 612, 622, 632. A second feeder F2 is electrically connected to a second input of each of power switches 612, 622, 632, First power switch 612 is electrically connected to an AC-side of a first AC/DC converter 610, with a maximum power conversion capacity of 50 kVA, wherein first power switch 612 is operable to selectively couple first AC/DC converter 610 to one of feeder F1 or feeder F2. Second power switch 622 is electrically connected to an AC-side of a second AC/DC converter 620, with maximum power conversion capacity of 25 kVA, wherein second power switch 622 is operable to selectively couple second AC/DC converter 620 to one of feeder F1 or feeder F2. Third power switch 632 is electrically connected to an AC-side of a third AC/DC converter 630, with maximum power conversion capacity of 25 kVA, wherein third power switch 632 is operable to selectively couple third AC/DC converter 630 to one of feeder F1 or feeder F2. Thus, the total power conversion capacity of the AC/DC converters of the MOP of FIG. 6A is 100 kVA.

FIG. 6B shows an example capability chart for the two-terminal MOP of FIG. 6A. The thick black line shows the possible reactive power injections based on conversion capacity between feeders F1 and F2 using the MOP of FIG. 6A, for different connection configurations of switches 612, 622, 632. Additionally, the combinations of reactive powers between the chart axes and the thick black line are also possible.

In an example, to transfer 50 kW from feeder F1 to feeder F2, then switch 612 can operate to connect feeder F1 to AC/DC converter 610, whilst switches 622 and 632 can operate to connect feeder F2 to AC/DC converters 620 and 630 respectively. With the switches connected as such, a total of 50 kVA can be transferred from F1 to the common DC node, and a total of 50 kVA can be transferred from the common DC node to F2, thus transferring 50 KW total from feeder F1 to feeder F2.

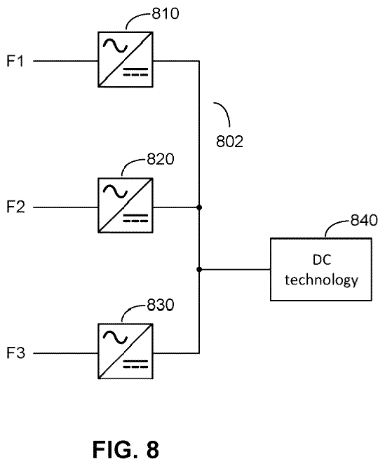

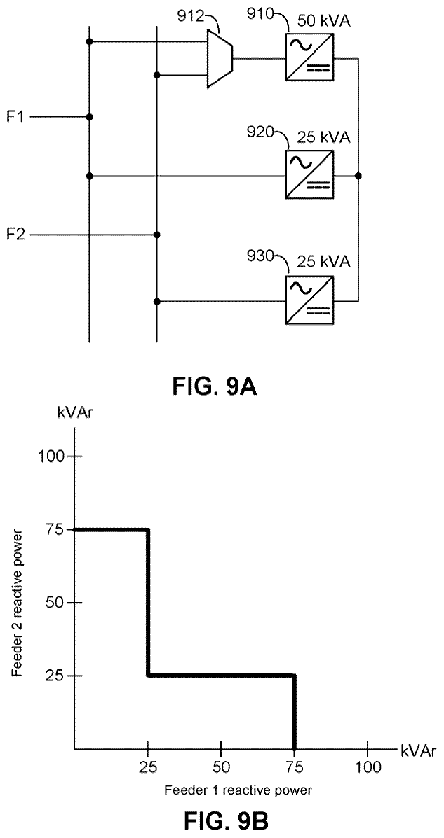

FIG. 7A shows a two-terminal MOP, with golden ratio converter sizing, in accordance with examples of the disclosure. A first feeder F1 is electrically connected to first inputs of each of power switches 712, 722, 732. A second feeder F2 is electrically connected to second inputs of each of power switches 712, 722, 732. First power switch 712 is electrically connected to an AC-side of a first AC/DC converter 710, with a maximum power conversion capacity of 50 kVA, wherein first power switch 712 is operable to selectively couple first AC/DC converter 710 to one of feeder F1 or feeder F2. Second power switch 722 is electrically connected to an AC-side of a second AC/DC converter 720, with maximum power conversion capacity of 31 kVA, wherein second power switch 722 is operable to selectively couple second AC/DC converter 720 to one of feeder F1 or feeder F2. Third power switch 732 is electrically connected to an AC-side of a third AC/DC converter 730, with maximum power conversion capacity of 19 kVA, wherein third power switch 732 is operable to selectively couple third AC/DC converter 730 to one of feeder F1 or feeder F2. Thus, the total power conversion capacity of the AC/DC converters of the MOP of FIG. 7A is 100 kVA.

FIG. 7B shows an example capability chart for the two-terminal MOP of FIG. 7A. The thick black line shows the possible power transfers based on conversion capacity between feeders F1 and F2 using the MOP of FIG. 7A, for different connection configurations of switches 712, 722, 732.

In an example, to transfer 50 KW from feeder F1 to F2, then switch 712 can operate to connect feeder F1 to AC/DC converter 710, whilst switches 722 and 72 can operate to connect feeder F2 to AC/DC converters 720 and 730 respectively. With the switches connected as such, a total of 50 kVA can be transferred from F1 to the common DC node, and a total of 50 kVA can be transferred from the common DC node to F2, thus transferring 50 kW total from feeder F1 to feeder F2.

FIG. 8 shows an example of a SOP connected to a DC technology at the DC bus, in accordance with examples of the disclosure. Various examples and embodiments herein provide benefits where there are one or more technologies, such as DC technology 840, connected to the common DC bus, such as common DC bus 802, which can inject or draw power into DC bus 802. DC technology 840 may include one or more of an electric vehicle, an energy storage system (such as a battery), a solar photovoltaic generator, a wind power generator, or power that has been transmitted as DC electric current via a transmission line, such as a High Voltage Direct Current (HVDC) cable.

FIG. 9A shows an example of a two-terminal multiplexed SOP, with a mix of reconfigurable and fixed converters, in accordance with examples of the disclosure. A first feeder F1 is electrically connected to a first input of power switch 912, and an AC-side of a second AC/DC converter 920, with maximum power conversion capacity of 25 kVA. A second feeder F2 is electrically connected to a second input of power switch 912, and an AC-side of a third AC/DC converter 930, with maximum power conversion capacity of 25 kVA. First power switch 912 is electrically connected to an AC-side of a first AC/DC converter 910, with maximum power conversion capacity of 50 kVA, wherein first power switch 912 is operable to selectively couple first AC/DC converter 910 to one of feeder F1 or F2.

The arrangement shown in FIG. 9A uses a combination of non-reconfigurable (fixed) converters and reconfigurable converters, to reduce the complexity of the multiplexer arrangement in situations where the desired capability chart supports such a configuration. In the arrangement of FIG. 9A, only the first AC/DC converter 910 of the three AC/DC converters uses a reconfigurable output stage.

FIG. 9B shows an example capability chart for the two-terminal multiplexed SOP of FIG. 9A. The thick black line shows the possible power transfers based on conversion capacity between feeders F1 and F2 using the MOP of FIG. 9A, for different connection configurations of switch 912. The capability chart of FIG. 9B could also be achieved using the configuration shown in FIG. 6A, however the configuration of FIG. 9A has the advantage of a reduced number of electromechanical switches, leading to a reduced size and complexity, whilst using the same AC/DC converter capacity as the example of FIG. 6A.

There are a number of potential use cases for the MOP. For example, in a maximum power transfer (MPT) mode, the MOP may be used to provide real power transfer, and so which converter sizing may be selected in order to optimise a main capability of real power transfer between feeders. In a unity power factor power transfer (UPT) mode, the real power that is needed to be transferred between feeders may vary significantly, and thus converter sizing may be optimised for flexibility, or improved coverage of the capability chart. In a static compensator (STATCOM) mode, it may be assumed that the MOP is used mostly for providing reactive power compensation, in order to reduce losses, improve voltage regulation, or improve power quality. In an optimal power flow (OPF) mode, both real and reactive power transfers may be expected to achieve some minimised distribution operating cost.

The systems and methods described herein facilitate increased network capacity and flexibility in a more cost-effective manner compared to conventional systems. The systems and methods herein have applications in electrical distribution feeder voltage control, distribution feeder power factor compensation and correction, load power factor correction, distribution network power loss reduction, and increasing electrical distribution capacity for increased load or generation capacity. Additionally, the MOP can provide benefits in feeder load balancing, phase balancing (where per-phase control is implemented), reduced distributed generation hosting capacity, and electrical supply restoration.

The examples and embodiments described herein describe a case where there are a greater number of converters compared to the number of feeders. However, these techniques described herein, including the modular construction arrangement, asymmetric converter sizing, and reducing a number of switches in the multiplexer matrix, also present a benefits in cases where there are as many or fewer converters compared to the number of feeders.

Various embodiments or examples of the disclosure provide an apparatus for power conversion at a node of an electrical distribution network, comprising a first quantity of electrical feeders, a second quantity of AC/DC converters, and a multiplexer arranged to electrically connect the first quantity of electrical feeders to the second quantity of AC/DC converters, wherein the second quantity is greater than the first quantity.

In some embodiments or examples of the disclosure, the power converters of the second quantity of AC/DC converters have varying maximum power capacities.

In some embodiments or examples of the disclosure, a maximum power capacity of each AC/DC converter of the second quantity of AC/DC converters is determined based on a desired set of desired power transfers for the node.

In some embodiments or examples of the disclosure, a maximum power capacity of each AC/DC converter of the second quantity of AC/DC converters is determined based on a bisection sizing approach.

In some embodiments or examples of the disclosure, a maximum power capacity of each AC/DC converter of the second quantity of AC/DC converters is determined based on a golden ratio sizing approach.

In some embodiments or examples of the disclosure, the first quantity of electrical feeders comprises two electrical feeders, and wherein the second quantity of AC/DC converters comprises at least three AC/DC converters.

In some embodiments or examples of the disclosure, a first AC/DC converter of the second quantity of AC/DC converters has a maximum power capacity of 0.5 per unit.

In some embodiments or examples of the disclosure, the multiplexer comprises a plurality of electromechanical switches.

Various embodiments or examples of the disclosure provide a method for power conversion at a node of an electrical distribution network, comprising providing a first quantity of electrical feeders, providing a second quantity of AC/DC converters, and connecting, via a multiplexer, each AC/DC converter of the second quantity of AC/DC converters to one electrical feeder of the first quantity of electrical feeders, wherein the second quantity is greater than the first quantity.

In some embodiments or examples of the disclosure a maximum power capacity of each AC/DC converter of the second quantity of AC/DC converters is determined based on a desired set of desired power transfers for the node.

In some embodiments or examples of the disclosure a maximum power capacity of each AC/DC converter of the second quantity of AC/DC converters is determined based on a bisection sizing approach.

In some embodiments or examples of the disclosure a maximum power capacity of each AC/DC converter of the second quantity of AC/DC converters is determined based on a golden ratio sizing approach.

In some embodiments or examples of the disclosure a first AC/DC converter of the second quantity of AC/DC converters has a maximum power capacity of 0.5 per unit.

In some embodiments or examples of the disclosure the multiplexer comprises a plurality of electromechanical switches.

All of the features disclosed in this specification (including any accompanying claims, abstract, and drawings) may be combined in any combination, except combinations where some features are mutually exclusive. Each feature disclosed in this specification, including any accompanying claims, abstract, and drawings, may be replaced by alternative features serving the same, equivalent, or similar purpose, unless expressly stated otherwise, Thus, unless expressly stated otherwise, each feature disclosed in one example of a generic series of equivalent or similar features.

The present teachings are not restricted to the details of any of the foregoing examples. Any novel combination of the features disclosed in this specification (including any accompanying claims, abstract, and drawings) may be envisaged. The claims should not be construed to cover merely the foregoing examples, but also any variants which fall within the scope of the claims.

1. An apparatus for power conversion at a node of an electrical distribution network, comprising:
a first quantity of electrical feeders;
a second quantity of AC/DC converters; and
a multiplexer arranged to electrically connect the first quantity of electrical feeders to the second quantity of AC/DC converters,
wherein the second quantity is greater than the first quantity.

2. The apparatus of claim 1, wherein the power converters of the second quantity of AC/DC converters have varying maximum power capacities.

3. The apparatus of claim 2, wherein a maximum power capacity of each AC/DC converter of the second quantity of AC/DC converters is determined based on a desired set of desired power transfers for the node.

4. The apparatus of claim 2, wherein a maximum power capacity of each AC/DC converter of the second quantity of AC/DC converters is determined based on a bisection sizing approach.

5. The apparatus of claim 2, wherein a maximum power capacity of each AC/DC converter of the second quantity of AC/DC converters is determined based on a golden ratio sizing approach.

6. The apparatus of claim 1, wherein the first quantity of electrical feeders comprises two electrical feeders, and wherein the second quantity of AC/DC converters comprises at least three AC/DC converters.

7. The apparatus of claim 1, wherein a first AC/DC converter of the second quantity of AC/DC converters has a maximum power capacity of 0.5 per unit.

8. The apparatus of claim 1, wherein the multiplexer comprises a plurality of electromechanical switches.

9. A method for power conversion at a node of an electrical distribution network, comprising:
providing a first quantity of electrical feeders;
providing a second quantity of AC/DC converters; and
connecting, via a multiplexer, each AC/DC converter of the second quantity of AC/DC converters to one electrical feeder of the first quantity of electrical feeders,
wherein the second quantity is greater than the first quantity.

10. The method of claim 9, wherein a maximum power capacity of each AC/DC converter of the second quantity of AC/DC converters is determined based on a desired set of desired power transfers for the node.

11. The method of claim 9, wherein a maximum power capacity of each AC/DC converter of the second quantity of AC/DC converters is determined based on a bisection sizing approach.

12. The method of claim 9, wherein a maximum power capacity of each AC/DC converter of the second quantity of AC/DC converters is determined based on a golden ratio sizing approach.

13. The apparatus of claim 9, wherein a first AC/DC converter of the second quantity of AC/DC converters has a maximum power capacity of 0.5 per unit.

14. The apparatus of claim 9, wherein the multiplexer comprises a plurality of electromechanical switches.
